(19) United States
(12) Patent Application Publication
(10) Pub. No.: US 2022/0276139 A1
(43) Pub. Date: Sep. 1, 2022

(54) COMPOSITIONS AND METHODS FOR CLEARING TISSUE

(71) Applicant: The University of Hong Kong, Hong Kong (CN)

(72) Inventors: Hei Ming Lai, Hong Kong (CN); Tak Mao Daniel Chan, Hong Kong (CN); Sou Ying Susan Yung, Hong Kong (CN)

(21) Appl. No.: 17/625,665

(22) PCT Filed: Jul. 8, 2019
(86) PCT No.: PCT/IB2019/055814

§ 371 Date: Jan. 7, 2022

(51) Int. Cl. G01N 1/34; G01N 1/30; C11D 7/08; C11D 7/32

(52) U.S. Cl. CPC G01N 1/34; G01N 1/30; C11D 7/08; C11D 7/32; C11D 7/329

(57) ABSTRACT

Investigation of fine tissue structures, such as those in non-neural, non-osseous tissues or organs, is best performed in intact tissue. Described herein are compositions and methods for clearing tissues for subsequent three-dimensional analysis. The compositions referred to herein as tissue clearing compositions are composed of four core components: (1) a homogenizing agent such as N-methylglucamine, urea, thiourea, guanidine, guanidinium chloride, lithium perchlorate, ethylenediamine, and derivatives thereof; (2) a water-soluble adjusting agent such as iohexol, sodium thiosulfate, polyethylene glycol, and derivatives thereof; (3) a lipid-soluble adjusting agent such as 2,2′-thiodiethanol, propylene glycol, and derivatives thereof; and (4) a borate compound such as boric acid, tetraboric acid, disodium tetraborate, and derivatives thereof. The disclosed tissue clearing compositions are particularly suitable for use with non-neural, non-osseous tissues or organs. The tissues or organs can be fresh, archived, or retrieved from paraffin wax-embedded tissues.

### FIELD OF THE INVENTION

The disclosed invention is generally in the field of tissue clearing and specifically in the area of analysis of biological tissues using a tissue clearing composition to make the biological tissues transparent.

### BACKGROUND OF THE INVENTION

Although biological specimens are intrinsically three-dimensional, the obscuring effects of light scattering hamper high-resolution deep tissue imaging. One method of visualizing thick tissues is by serially cutting them into thin sections and using those sections to reconstruct a three-dimensional image with computational methods. However, not only is this method laborious, but it is also limiting in instances where the true three-dimensional nature of a tissue cannot be ascertained by thin sections. Investigation of fine tissue structures, such as those in non-neural, non-osseous tissues or organs, is best performed in intact tissue.

In an effort to retain the authentic three-dimensional structure of a tissue, there has been a surge of interest in developing tissue clearing agents and techniques. Tissue clearing techniques directly turn tissues transparent, allowing imaging deep within the tissue. With the use of microscopes capable of imaging a selective plane of depth (i.e., optically sectioning the tissue), a three-dimensional (3D) image can be rapidly acquired, with no cutting artifacts or sample destruction in serial-sectioning methods. Good optical clearing methods facilitate deep tissue biological imaging by mitigating light scattering in situ while preserving tissue integrity for accurate signal reconstruction.

Tissue clearing techniques often alter the physicochemical properties of the tissue. Presently available compositions for clearing tissues may cause substantial swelling that leads to structural distortion. In some cases, clearing agents are only suitable for very small samples due to their limited clearing efficacy. Existing clearing agents also take a long time to clear tissues and require multiple steps for tissue treatment before optical clearing. Additionally, they are not compatible with archived tissues that have been fixed with formalin for a long time.

The overall process of tissue clearing can be viewed as tissue refractive index (RI) homogenization (that is, homogenizing or making more equal the refractive index of the tissue). The currently available methods can be classified into (1) aqueous-based simple RI homogenization, (2) delipidation-assisted RI homogenization, and (3) organic solvent-based RI homogenization (Table 1). The latter two categories each have their own strengths, but can cause substantial tissue damage and are typically not suitable for high resolution imaging studies where the finest structures are to be investigated in detail.

TABLE 1
Currently available methods for tissue clearing

| | Aqueous- | Delipidation- | Organic solvent- |
|---|---|---|---|
| | based RI- | assisted RI- | based RI- |
| | homogenization | homogenization | homogenization |
| Examples | ScaleS, Clear^{T}, | CLARITY ™, | BABB ™, |
| | SeeDB2S, Ce3D | CUBIC ™, | 3DISCO ™, |
| | | SWITCH ™, | uDISCO, |
| | | FASTClear, | FASTClear, |
| | | SHIELD | PEGASOS |
| Advantages | Compatible with | Best results with | Best for lipid- |
| | lipophilic tracers | immunostaining, | rich regions |
| | and subsequent | least tissue | |
| | ultrastructural | discoloration | |
| | studies | | |
| Dis- | Incompatible/ | Incompatible with | Incompatible with |
| advantages | poorly | lipophilic tracers, | lipophilic tracers, |
| | compatible with | ultrastructural | ultrastructural |
| | immunostaining, | evaluation, can be | evaluation, |
| | comparatively | slow for lipid-rich | significant tissue |
| | poor tissue | regions, | discoloration and |
| | transparency | comparatively | autofluorescence, |
| | | long tissue | can be incompatible |
| | | processing | with fluorescent |
| | | time | proteins |

Conversely, even though category (1) causes the least damage, its tissue clearing efficacy is not as good as that of the other two methods. This creates a need for improved aqueous-based tissue clearing methods that lead to improved tissue transparency with maximal structural preservation. Preferably, these methods are suitable for use with human tissues, and are not only compatible with all existing chemical staining methods and electron microscopy, but are also compatible with future diagnostic and research use.

There is an increased need for 3D imaging and analysis in biomedical research. 3D imaging aids in the understanding of biological structures and function of organs during development and pathogenesis. Tissue clearing after staining leads to improved quality of images.

It is an object of the invention to provide tissue clearing compositions with improved tissue clearing capabilities, especially for non-neural, non-osseous tissues or organs.

It is a further object of the invention to provide kits for clearing tissues.

It is a further object of the invention to provide improved methods of clearing tissues, especially human tissues.

### BRIEF SUMMARY OF THE INVENTION

Disclosed herein are compositions and methods for clearing tissues useful for, for example, subsequent 3D analysis. In some forms, the disclosed tissue clearing compositions are composed of four core components:

(1) a homogenizing agent (such as N-methylglucamine urea, thiourea, guanidine, guanidinium chloride, lithium perchlorate, ethylenediamine, and derivatives thereof);

(2) a cytoplasmic, water-soluble RI adjusting agent (such as iohexol, sodium thiosulfate, polyethylene glycol, and derivatives thereof);

(3) a membrane, lipid-soluble RI adjusting agent (such as 2,2′-thiodiethanol (TDE), propylene glycol, and derivatives thereof); and

(4) a borate compound in the forms of a hydrogen or metal borate (such as boric acid, tetraboric acid, disodium tetraborate, and derivatives thereof).

In preferred forms, the disclosed tissue clearing compositions do not contain strong detergents or strong denaturants, which allows for the preservation of lipid membranes for lipophilic tracing and subsequent imaging. In some forms, the disclosed methods can involve a single step incubation of the tissue in a disclosed tissue clearing composition.

Different forms of the tissue clearing compositions are particularly useful for different tissues and source species, such as a composition specific for non-neural, non-osseous tissues or organs, non-neural, non-osseous pathological tissues or organs, or non-neural, non-osseous human tissues or organs. Some specific tissue clearing compositions are particularly useful for tissues retrieved from archived sources (such as those archived for up to about 50 years) versus recently fixed tissues (such as those fixed within about 3 weeks to about 3 months, which is typical for human tissues).

In some forms, the disclosed tissue clearing compositions can contain N-methylglucamine as the homogenizing agent, iohexol as the water-soluble RI adjusting agent, 2,2′-thiodiethanol as the lipid-soluble RI adjusting agent, and boric acid as the borate compound. In some forms, the concentration of each of N-methylglucamine, iohexol, and 2,2′-thiodiethanol ranges from about 10 to about 50 w/v %, and the molar ratio of N-methylglucamine to boric acid is between about 0.5 and about 2. In some forms, the tissue clearing compositions can contain about 20% w/v N-methylglucamine, about 32% w/v iohexol, about 25% w/v 2,2′-thiodiethanol, and boric acid at a molar ratio of about 1 with N-methylglucamine.

Preferably, the tissue clearing compositions have improved tissue clearing capacity for non-neural, non-osseous tissues or organs relative to corresponding compositions without the borate compound, relative to corresponding compositions with the borate compound replaced by an organic or inorganic acid, or relative to both.

Preferably, the tissue clearing compositions have improved tissue clearing capacity for non-neural, non-osseous tissues or organs, relative to neural tissues or organs, such as the brain.

As may be suitable for any particular application, the concentrations of the four core components of the tissue clearing compositions can vary. In some forms, the compositions are suitable for robust, general applications. In some forms, the compositions are suitable for use with fresh tissues. In some forms, the compositions are suitable for use with long-fixed tissues. In some forms, the compositions are suitable for in vivo clearing applications.

The disclosed tissue clearing compositions can include additional components that, for example, make the compositions useful or tailored for specific tissues and source species to which it is to be applied. In some forms, the disclosed tissue clearing compositions are compatible with, for example, further processing methods for histology and electron microscopy studies, other tissue clearing methods, different tissue staining methods (such as immunohistochemistry, chemical staining, transgenic cell labelling methods, imaging probes, tissue in situ chemistry, and viral tracing methods), or combinations thereof.

Additional advantages of the disclosed methods and compositions will be set forth in part in the description which follows, or may be learned by practice of the disclosed methods and compositions. The advantages of the disclosed methods and compositions will be realized and attained by means of the elements and combinations particularly pointed out in the appended claims. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the disclosed methods and compositions and together with the description, serve to explain the principles of the disclosed method and compositions.

FIG. 1 illustrates an exemplary protocol for processing a formalin-fixed, paraffin-embedded renal or tumor tissue with an example of the disclosed tissue clearing compositions, i.e., OPTIClear B (20 w/v % N-methylglucamine, 25 w/v % 2,2′-thiodiethanol, 32 w/v % iohexol, and 6.335% w/v boric acid).

### DETAILED DESCRIPTION OF THE INVENTION

Disclosed herein are compositions and methods for clearing tissues useful for, for example, subsequent 3D analysis. Investigation of fine tissue structures, such as those in non-neural, non-osseous tissues or organs, is best performed in intact tissue. The disclosed compositions and methods eliminate the need for sectioning of tissue, making the procedure faster than conventional histological study (such as 12-15 times faster). The transparency achieved by using the disclosed compositions and methods can enhance observation capability and signal detection sensitivity of cellular structures, including, for example, fluorescent and non-fluorescent cellular structures. The disclosed compositions and methods also allow for 3D viewing of the tissue in any orientation, either whole, or in virtual sections, and obviate other issues associated with conventional 3D imaging techniques, such as loss of slides in conventional histology.

It was discovered that, by tuning the RI of different portions of cells and tissues (such as aqueous portions, lipid/hydrophobic portions, protein portions, cytoplasm, and nucleus) to be matched (identical or similar), relative transparency or translucence of intact or whole tissue can be achieved. It was discovered that by using at least one agent that adjusts the RI of aqueous portions of the tissue and one agent that adjusts the RI of lipid/hydrophobic portions of the tissue, the RI of these different tissue portions can be made identical or brought closer together in value. Such tuning of the RI of different tissue portions results in less refractive distortion and thus increased transparency or translucence. Generally, the adjusting agents are chosen to segment or fractionate to the tissue component they are intended to adjust. This can generally be accomplished by using, for example, relatively hydrophilic agents for adjusting the RI of aqueous portions of the tissue and relatively hydrophobic agents for adjusting the RI of the lipid/hydrophobic portions of the tissue. It is preferred that the adjusting agents are selected to adjust the RI of their target tissue portions toward the RI of the other tissue portions.

It was also discovered that, because the adjusting agents used to adjust the RI of tissue portions do not effectively become physically apposed to some biomacromolecules in tissue, such as some undenatured proteins, and because such unadjusted, undenatured proteins can affect the RI of the tissue portions in which they reside, it is useful to use, for some tissues, a homogenizing agent that renders some or all of the problematic biomacromolecules more accessible to the adjusting agents. Such homogenizing agents allow for more complete tuning or matching of the RIs of different tissue portions.

It was further discovered that the addition of a borate compound, such as boric acid, that can react with one or more components of the tissue clearing compositions can improve tissue transparency relative to corresponding tissue clearing compositions without the borate compound, relative to corresponding tissue clearing compositions with the borate compound replaced by an organic or inorganic acid, or relative to both.

After the basic discoveries discussed above, it was realized that, because different tissues contain different components, the refractive indices of tissue portions in different tissues can be different. Because of this, it was realized that the results of the disclosed compositions and methods can be improved by choosing agents, their concentrations/proportions, or combinations thereof, that can adjust the RI of the target tissue portions to the correct extent based on the particular nature of the components of the target tissue. This feature of the selection of the agents and the concentrations/proportions of the agents to be tuned or matched to a given target tissue can generally be simplified by noting the RI of the given portions of the target tissue and choosing agents and the concentrations/proportions of the agents to tune the RI of different portions of that tissue to the same or similar RI values. In this way, the present discoveries allow the formulation of the tissue clearing compositions tuned or matched to a wide variety of different tissues by following the clear principles that were discovered and developed.

In some forms, the disclosed tissue clearing compositions feature a low viscosity, a low osmolality, a low concentration of chemicals, or combinations thereof. These properties translate to easier manipulation, faster tissue clearing times, single-step methodologies, better tissue preservation, lower cost of production, or combinations thereof.

In preferred forms, the disclosed tissue clearing compositions do not contain strong detergents or strong denaturants, which allows for the preservation of lipid membranes for lipophilic tracing and subsequent imaging. In some forms, the disclosed tissue clearing compositions do not contain detergents or denaturants. In some forms, the disclosed methods can involve a single step incubation of the tissue in a disclosed tissue clearing composition.

In some forms, the disclosed tissue clearing compositions exhibit improved clearing capabilities in non-neural, non-osseous tissues or organs, which have been difficult to accomplish with other methods and other compositions, optionally allowing for visualization of structures down to 300 μm within about 3 hours. In some forms, the disclosed tissue clearing compositions can be used to clear archived and/or formalin-fixed, paraffin-embedded (FFPE) tissues. In some forms, the disclosed tissue clearing compositions can be used to clear biopsied tissues from clinical settings to facilitate pathological diagnoses. In some forms, long-term storage after tissue clearing is feasible.

### I. Definitions

The term “tissue clearing” as used herein refers to a process that has the effect of tuning, matching, or homogenizing the refractive index (RI) of tissue, generally resulting in an increase in the transparency of the tissue. The transparency of the tissue can be quantitatively determined via optical absorption spectrophotometry, such as measuring light transmission through the tissue, or confocal microscopy.

The term “homogenizing” as used herein refers to the act of making a composition, such as a solution, tissue, or tissue portion, uniform throughout by blending unlike elements or features. For example, in the context of the RI of tissue, homogenization produces a more even or matched RI throughout the tissue.

The term “tuning” as used herein in the context of tissue RI refers to the act of making different tissue portions more uniform in RI throughout. For example, in the context of the RI of tissue, tuning produces a more even or matched RI throughout the tissue. In the context of agents used to tune tissue RI, tuning refers to selecting agents and proportions of agents to accomplish the tuning of the tissue RI.

The term “matching” as used herein in the context of tissue RI refers to the act of making different tissue portions more uniform in RI to each other. For example, in the context of the RI of tissue, matching produces a more even or matched RI throughout the tissue. In the context of agents used to match tissue RI, matching refers to selecting agents and proportions of agents to accomplish the matching of the tissue RI.

The term “homogenizing agent” as used herein refers to a compound or composition that increases the homogeneity of a difficult to blend mixture (such as tissue).

The terms “water-soluble adjusting agent” and “water-soluble RI adjusting agent” as used herein refer to a compound or composition that can selectively adjust the RI of the aqueous compartments of tissue, such as the cytoplasm, cytosol, extracellular compartments, interstitial fluid, blood, plasma, and lymph.

The term “water-soluble” as used herein in reference to a component refers to the ability of the component to dissolve in water.

The terms “lipid-soluble adjusting agents” and “lipid-soluble RI adjusting agents” as used herein refer to a compound or composition that can selectively adjust the RI of the lipid-rich, membranous, or adipose compartments of tissue.

The term “lipid-soluble” as used herein in reference to a component refers to the ability of the component to dissolve in fats, oils, lipids, and non-polar solvents.

The term “refractive index adjusting agent” or “RI adjusting agent” as used herein refers to a compound or composition that selectively adjusts the RI of either lipid-rich or aqueous compartments of tissue.

The term “refractive index” or “RI” as used herein refers to the ratio of the speed of radiation (such as in electromagnetic radiation or light) in one medium (such as air, glass, or a vacuum), to that in another medium.

The term “archived tissue’” as used herein refers to a tissue that has been preserved for short-term or long-term storage. Tissue may be preserved by heat fixation, immersion in a fixative solution, blood flow perfusion, freezing, formalin-fixation and paraffin-embedding, or any other chemical or other available method.

The term “denaturant” refers to agents that can cause denaturation of biomacromolecules such as proteins and/or nucleic acid. Denaturation is a process in which proteins or nucleic acids lose the quaternary structure, tertiary structure, and/or secondary structure which is present in their native state. Denatured proteins can exhibit a wide range of characteristics, from conformational change and loss of solubility to aggregation due to the exposure of hydrophobic groups. In some forms, denaturants can include chaotropic agents such as urea, guanidinium chloride, guanidine, and lithium perchlorate.

The term “chaotropic agent” refers to molecules in water solution that can disrupt the hydrogen bonding network between water molecules, i.e., exert chaotropic activity. This has an effect on the stability of the native state of other molecules in the solution, mainly macromolecules (such as proteins and nucleic acids) by weakening the hydrophobic effect. For example, a chaotropic agent can reduce the amount of order in the structure of a protein formed by water molecules, both in the bulk and the hydration shells around hydrophobic amino acid and can cause its denaturation.

In some forms, a chaotropic agent can disrupt the structure of, and denatures, macromolecules such as proteins and nucleic acids (e.g., DNA and RNA). Chaotropic agents increase the entropy of the system by interfering with intermolecular interactions mediated by non-covalent forces such as hydrogen bonds, van der Waals forces, and hydrophobic effects. Macromolecular structure and function is dependent on the net effect of these forces, therefore it follows that an increase in chaotropic agents in a biological system will denature macromolecules. Tertiary protein folding is dependent on hydrophobic forces from amino acids throughout the sequence of the protein. Chaotropic agents can decrease the net hydrophobic effect of hydrophobic regions because of a disordering of water molecules adjacent to the protein. This solubilizes the hydrophobic region in the solution, thereby denaturing the protein. This is also directly applicable to the hydrophobic region in lipid bilayers; if a critical concentration of a chaotropic agents is reached (in the hydrophobic region of the bilayer) then membrane integrity can be compromised, and the cell will lyse.

Chaotropic salts that dissociate in solution exert chaotropic effects via different mechanisms. Whereas chaotropic compounds such as ethanol interfere with non-covalent intramolecular forces as outlined above, chaotropic salts can have chaotropic properties by shielding charges and preventing the stabilization of salt bridges. Hydrogen bonding is stronger in non-polar media, so salts, which increase the chemical polarity of the solvent, can also destabilize hydrogen bonding. Mechanistically this is because there are insufficient water molecules to effectively solvate the ions. This can result in ion-dipole interactions between the salts and hydrogen bonding species which are more favorable than normal hydrogen bonds. Exemplary chaotropic agents include n-butanol, ethanol, guanidinium chloride, lithium perchlorate, lithium acetate, magnesium chloride, phenol, 2-propanol, sodium dodecyl sulfate, thiourea, and urea.

The term “miscible” refers to forming a homogeneous mixture when mixed together. In some forms, this term refers to the capability of mixing in any ratio without separation of two phases.

The term “solid organ” refers to internal organs that have a firm tissue consistency and is neither hollow (such as the organs of the gastrointestinal tract) nor liquid (such as blood). Exemplary solid organs include the heart, kidney, liver, lungs, and pancreas.

The term “derivative” refers to chemical compounds/moieties with a structure similar to that of a parent compound/moiety but different from it in respect to one or more components, functional groups, atoms, etc. The derivatives can be formed from the parent compound/moiety by chemical reaction(s). The differences between the derivatives and the parent compound/moiety can include, but are not limited to, replacement of one or more functional groups with one or more different functional groups or introducing or removing one or more substituents of the hydrogen atoms. In some forms, the derivatives can also differ from the parent compound/moiety with respect to the protonation state. In some forms, the derivatives can be derived from the parent compound/moiety via an acid-base reaction. Preferably, the derivatives retain the bioactivity of the parent compound/moiety, such as at least 100%, 95%, 90%, 85%, 80%, 75%, 70%, 65%, and 60% of the bioactivity of the parent compound/moiety. In some forms, the derivatives possess higher activity compared to the parent compound/moiety.

The term “organic acid” refers to organic compounds with acidic properties. The he most common organic acids are the carboxylic acids, whose acidity is associated with their carboxyl group —COOH.

### II. Compositions

Provided herein are compositions for clearing tissues for, for example, subsequent 3D analysis. The disclosed compositions can include additional components that, for example, make the composition useful or tailored for specific tissues and source species to which it is to be applied.

The physical basis of opaqueness lies on bending of light as it passes through the boundary of two media with different RIs, thereby leading to a perceived boundary. Adjusting the RI of one or both media such that the two RIs are close to or equal to each other can eliminate the bending of light and avoid the perceived boundary.

In tissues, the tissue compartments have varying properties and therefore different RIs. This is the origin of tissue opacity. For example, the lipid membranes/compartments in the tissues generally have higher RIs (˜1.45) compared to those of the extracellular spaces (˜1.37); the interfaces between them would cause light to bend and scatter as a result of refraction. By choosing chemicals with specified optical properties that preferentially dissolve in specified compartments, one can adjust the refractive indices of these compartments accordingly such that they match with one another, producing an optical homogeneity despite physical inhomogeneity—the structures are not altered while optically they look the same, that is, transparency.

Accordingly, the use of a lipid-soluble adjusting agent plus a water-soluble RI adjusting agent can lead to optical homogenization of the two major physical compartments within the tissue. In some forms, the water-soluble adjusting agent might not be physically apposed closely enough to proteins, leading to a certain aspect of physical inhomogeneity that impedes optical homogenization. This explains why all currently existing tissue clearing formulas used denaturants to achieve better clearing effect (e.g., urea in ScaleA2 and ScaleS; formamide in Clear^{T}; SDS in CLARITY™) However, it was reasoned that denaturation might not be necessary if physical homogeneity good enough for optical homogenization could be achieved. No denaturation or partial, controlled denaturation of proteins would aid in avoiding the side effects of tissue and antigen destruction, tissue expansion, and the incompatibility with lipophilic tracers commonly associated with denaturation.

In most forms, the disclosed tissue clearing compositions employ the optic characteristics of various chemicals to reduce the loss of light passing through a tissue sample and thereby increase light retrieval efficiency. Further, the disclosed tissue clearing compositions employ a homogenization agent to improve physical homogeneity of the tissue sample. The disclosed tissue clearing compositions also employ a borate compound to enhance the tissue clearing efficacy of the tissue clearing compositions, especially for non-neural, non-osseous tissues or organs.

In some forms, the disclosed tissue clearing compositions are composed of four core components: (1) a homogenizing agent, (2) a water-soluble adjusting agent, (3) a lipid-soluble adjusting agent, and (4) a borate compound. In some forms, the water-soluble adjusting agent is a water-soluble RI-adjusting agent. In some forms, the lipid-soluble adjusting agent is a lipid-soluble RI-adjusting agent.

In some forms, the tissue clearing compositions have a refractive index between about 1.4 and about 1.5 at 25° C., such as about 1.41, about 1.42, about 1.43, about 1.44, about 1.45, about 1.46, about 1.47, about 1.48, about 1.49, and about 1.50.

In some forms, the tissue clearing compositions have improved tissue clearing capacity for non-neural, non-osseous tissues or organs relative to corresponding compositions without the borate compound, relative to corresponding compositions with the borate compound replaced by an organic or inorganic acid, or relative to both. Such comparisons can be performed by comparing the opaqueness of the two parallel tissue sample groups: one group treated by the tissue clearing composition and the other group treated by the corresponding composition without the borate compound or with the borate compound replaced by an organic or inorganic acid. The opaqueness of samples can be measured by optical transmission.

In some forms, the tissue clearing compositions have worsened tissue clearing capacity for neural tissues or organs relative to corresponding compositions without the borate compound, relative to corresponding compositions with the borate compound replaced by an organic acid or inorganic acid, or relative to both. Such comparisons can be performed by comparing the opaqueness of the two parallel tissue sample groups: one group treated by the disclosed tissue clearing composition and the other group treated by the corresponding composition without the borate compound or with the borate compound replaced by an organic acid or inorganic acid. The opaqueness of samples can be measured by optical transmission.

In some forms, the tissue clearing composition shows improved tissue clearing capacity for non-neural, non-osseous tissues or organs, relative to neural tissues or organs. Such comparisons can be performed by comparing the opaqueness of the post-treatment non-neural, non-osseous tissue or organ to the opaqueness of the post-treatment neural tissue or organ. For example, the comparison can be performed between a post-treatment kidney sample and a post-treatment brain sample. The opaqueness of samples can be measured by optical transmission.

In some forms, the non-neural, non-osseous tissues or organs are non-neural, non-osseous solid organs such as the heart, kidney, liver, lungs, and pancreas. In some forms, the solid organ is kidney. In some forms, the neural tissue or organ is the brain.

In some forms, the non-neural, non-osseous tissues or organs are non-neural, non-osseous pathological tissues or organs, such as tumor tissues. In some forms, the organic acid can be acetic acid, succinic acid, maleic acid, malic acid, glutamic acid, aspartic acid, lactic acid, formic acid, citric acid, oxalic acid, uric acid, or derivatives thereof. In some forms, the inorganic acid can be hydrochloric acid, sulphuric acid, nitric acid, or phosphoric acid.

A. Homogenizing Agents

Homogenization is any of several processes used to make a mixture of two mutually non-soluble liquids the same or similar throughout. This is typically achieved by turning one of the liquids into a state consisting of extremely small particles distributed uniformly throughout the other liquid. Homogenizing agents are products which improve the homogeneity of difficult to blend mixtures. This facilitates true homogenization of water-soluble and water-insoluble agents together with the tissue components to achieve better optical homogeneity.

In some forms, the homogenizing agent is a denaturant of proteins, nucleic acids, or a combination thereof. Denaturation of these biomacromolecules, especially proteins, can facilitate physical homogenization because the higher-order structures of these biomacromolecules are disrupted. This is in-part due to the fact that the RI-adjusting agents, especially the water-soluble RI adjusting agent, can be closely apposed to the biomacromolecules after denaturation, including areas that are not solvent-accessible prior to denaturation, thereby achieving optical homogenization at the molecular scale and leading to more effective tissue clearing.

In preferred forms, the homogenizing agent is not a strong denaturant of proteins, nucleic acids or a combination thereof, that can cause aggregation and precipitation of the denatured biomacromolecules.

In some forms, the denaturant is a chaotropic agent. Using chaotropic agents as the denaturant has the advantage of avoiding aggregation of denatured biomacromolecules, especially proteins, because the chaotropic agents can decrease the net hydrophobic effect of the hydrophobic regions of the biomacromolecules exposed to the solvent. This helps to solubilize the hydrophobic regions of the denatured biomacromolecules.

Preferably, the concentration of the chaotropic agent is below the critical concentration for lipid bilayers so that it cannot solubilize the hydrophobic region of the lipid bilayer or disrupt the membrane integrity of the cells.

Exemplary homogenizing agents include, but are not limited to, N-methylglucamine, urea, thiourea, guanidine, guanidinium chloride, lithium perchlorate, ethylenediamine, triethanolamine, triethylamine, tetraethylammonium, and derivatives thereof. However, as is understood by those of skill in the art, there are numerous other agents or methods known to those of skill in the art that can be used to homogenize a mixture. Such agents and methods can be used with the disclosed compositions and methods.

In some forms of the tissue clearing compositions, N-methylglucamine can be used as a homogenizing agent. In other forms, urea may be used as a homogenizing agent. In some forms, ethylenediamine can be used as a homogenizing agent.

The final concentration of the homogenizing agent in the tissue clearing composition can vary. However, higher concentrations of homogenizing agent may compromise tissue integrity or fluorescent protein signal intensities. In some forms, the concentration of urea in the tissue clearing compositions can range from about 5 to about 60 w/v % or from about 10 to about 50 w/v %, such as from about 10 to about 24 w/v %. Preferably, the concentration of urea is about 10 w/v %. In some forms, the concentration of N-methylglucamine in the tissue clearing compositions can range from about 10 to about 50 w/t %. Preferably, the concentration of N-methylglucamine is about 20 w/t %.

B. Adjusting Agents

In some forms, the adjusting agents are refractive index adjusting agents.

RI differences between two opposing media cause bending of light paths and can be eliminated by tuning each media's RIs to match one another. In the context of tissues, tuning RIs of different cellular compartments (such as those of the nucleus, cytoplasm, and membrane) by selectively solubilizing chemicals in them leads to a minimally-destructive, high-efficacy tissue clearing effect.

In some forms, the water-soluble adjusting agent, the lipid-soluble adjusting agent, or both have a RI higher than that of water at 25° C.

In some forms, the water-soluble adjusting agent, the lipid-soluble adjusting agent, or both have a RI between about 1.40 and about 1.50 at 25° C., for example, about 1.40, about 1.41, about 1.42, about 1.43, about 1.44, about 1.45, about 1.46, about 1.47, about 1.48, about 1.49, and about 1.50.

In some forms, the RI of the water-soluble adjusting agent is at or within about 10%, about 8%, about 5%, or about 2% of the RI of the lipid-soluble adjusting agent at 25° C.

Water-soluble RI adjusting agents selectively adjust the RI of the aqueous compartments of the tissue, such as the cytoplasm, cytosol, extracellular compartments, interstitial fluid, blood, plasma, and lymph. Water-soluble RI adjusting agents suitable for use with the disclosed tissue clearing compositions include, but are not necessarily limited to agents such as iohexol, sodium thiosulfate, polyethylene glycol, and derivatives thereof. In other forms, water-soluble adjusting agents may include metrizamide, iodixanol, diatrizoate sodium, sodium iodide, and derivatives thereof. In some forms, the concentration of the water-soluble adjusting agent is between about 5 and about 60 w/v % or between about 10 and about 50 w/v %.

Lipid-soluble RI adjusting agents selectively adjust the RI of the lipid-rich, membraneous, or adipose compartments of the tissue. In some forms, the lipid-soluble RI adjusting agents are miscible with water. Lipid-soluble RI adjusting agents suitable for use with the disclosed tissue clearing composition include, but are not necessarily limited to agents such as 2,2′-thiodiethanol (TDE), propylene glycol, and derivatives thereof. In other forms, lipid-soluble RI adjusting agents can include glycerol, ethylene glycol, sodium dodecyl sulphate, trimethylamine, triethanolamine, triethanolamine-borate acid (1:1) adduct, and derivatives thereof. In some forms, the concentration of the lipid-soluble adjusting agent is between about 5 and about 70 w/v % or between about 10 and about 50 w/v %.

The suitability of specific RI adjusting agents may be determined using various assays. In some forms, the assay involves incubating a tissue homogenate in various concentrations of the adjusting agent in the presence of a homogenizer (such as N-methylglucamine or urea). Preferably, the assay includes both a water-soluble and a lipid-soluble adjusting agent to achieve the desirable reduction in homogenate opacity. Homogenate opacity may be measured by using a spectrophotometer over UV light, visible light, and near- and far-infrared light ranges.

C. Borate Compounds

The tissue clearing composition also includes a borate compound. In some forms, the borate compound is a hydrogen or metal borate in an anhydrous or hydrous form. Exemplary hydrogen borates include boric acid (H₃BO₃), metaboric acid (H₃B₃O₆), and tetraboric acid (H₂B₄O₇). Exemplary metal borates contain a boron-containing oxyanion selected from one of the following: metaborates (e.g., BO₂⁻), diborate (e.g., B₂O₅⁴⁻), triborate (e.g., B₃O₇⁵⁻), tetraborate (e.g., B₄O₇²⁻, B₄O₅(OH)₄²⁻, B₄O₉⁶⁻, and combinations thereof), and hydroxyborate (e.g., B(OH)₄⁻). In some forms, the borate compound is boric acid or tetraboric acid. In some forms, the borate compound is disodium tetraborate, such as disodium tetraborate anhydrous (i.e., Na₂B₄O₇), disodium tetraborate pentahydrate (i.e., Na₂B₄O₇.5H₂O), disodium tetraborate decahydrate (i.e., Na₂B₄O₇.10H₂O), disodium tetraborate octahydrate (i.e., Na₂B₄O₅(OH)₄.8H₂O), and combinations thereof.

In some forms, the borate compound can produce the tetrahydroxyborate anion, B(OH)₄⁻ in solution, which can form covalent or non-covalent conjugates with other components of the tissue clearing agent, preferably the homogenizing agent. Covalent conjugates can be generated through dehydration reactions, thereby producing borate eaters. Exemplary covalent conjugates include borate esters. Non-covalent conjugates can be generated via hydrogen-bonding interactions. Further, the tetrahydroxyborate anion can also form covalent and non-covalent linkages with reactive chemical groups of proteins, cells, tissues, or combinations thereof from the tissue sample upon physical contact.

The scheme below illustrates examples of covalent linkages and non-covalent linkages formed between the tetrahydroxyborate anion and hydroxyl groups from other chemical entities.

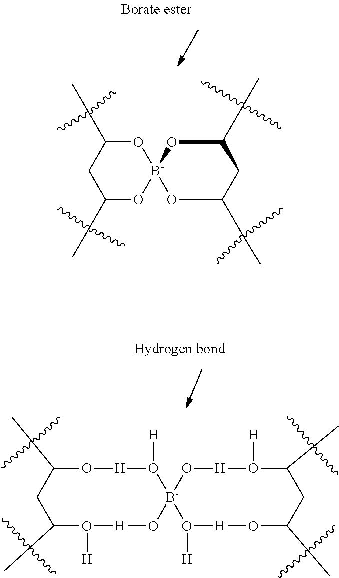

The use of the borate compound in the compositions can adjust the ionic strength of the medium where the compositions are dissolved or suspended. In addition, borates are weak bases and thus solutions of borates can function as basic buffer solutions. Basic pH can promote coupling reactions between the borate compound and reactive amines from the homogenizing agent and/or the proteins, cells or tissues from the tissue sample.

Boric acid can react with N-methylglucamine to form a covalent cyclic adduct as shown in the scheme below. This adduct can be transformed to a zwitterion upon protonation of the amine group. Zwitterions provide strong hydration through electrostatic interaction with water molecules.

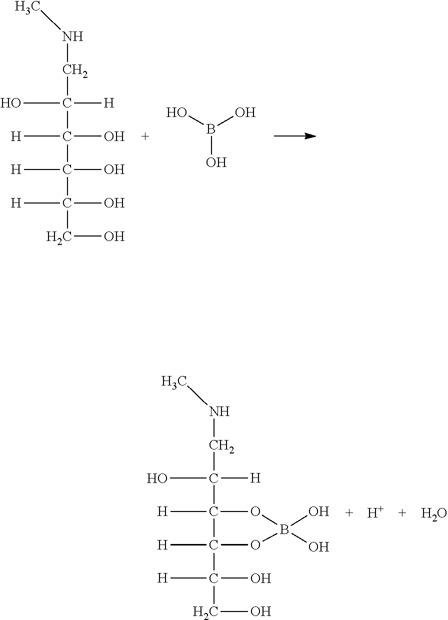

In some forms, the molar ratio of the homogenizing agent to the borate compound is between about 0.5 and about 2. Preferably, the molar ratio of the homogenizing agent to the borate compound is about 1.

D. Excipients

The compositions disclosed herein may additionally contain one or more excipients, which, as used herein, includes any and all solvents, dispersion media, diluents, or other liquid vehicles, dispersion or suspension aids, surfactants, isotonic agents, thickening or emulsifying agents, preservatives, solid binders, lubricants and the like, and combinations thereof, as suited to the particular composition. Except insofar as any conventional excipient medium is incompatible with a substance or its derivatives, such as by producing any undesirable biological effect or otherwise interacting in a deleterious manner with any other component(s) of the pharmaceutical composition, its use is contemplated to be within the scope of this disclosure.

In some forms, the liquid vehicles comprise aqueous media selected from water, acid solutions, and buffered solutions. Suitable acid solutions include hydrochloric acid, nitric acid, phosphoric acid, and sulfuric acid. Suitable buffered solutions include phosphate-buffered saline (pH 6.8-7.6) and Tris-HCl buffer (pH 6.8-7.6). The aqueous media may contain sodium azide such as 0.01-0.05 w/v %.

In some forms, the tissue clearing compositions have a pH in the range from about 5 to about 9, from about 5.5 to about 8.5, from about 6 to about 8, or from about 7 to about 10. In some forms, the pH of the compositions can be adjusted to the desired range or value by titrating one or more acid solutions. In some forms, no pH adjustment is needed.

In some forms, the compositions contain one or more isotonic agents such as sodium chloride (e.g., 142-148 mM), potassium chloride (e.g., 3-7 mM), sodium lactate (e.g., 28-32 mM), calcium chloride (e.g., 1.2-2.4 mM), and glucose (e.g., 5-7 mM).

E. Specific Compositions

In some forms, the homogenizing agent can be about 5 to about 60%, about 5 to about 59%, about 5 to about 58%, about 5 to about 57%, about 5 to about 56%, about 5 to about 55%, about 5 to about 54%, about 5 to about 53%, about 5 to about 52%, about 5 to about 51%, about 5 to about 50%, about 5 to about 49%, about 5 to about 48%, about 5 to about 47%, about 5 to about 46%, about 5 to about 45%, about 5 to about 44%, about 5 to about 43%, about 5 to about 42%, about 5 to about 41%, about 5 to about 40%, about 5 to about 39%, about 5 to about 38%, about 5 to about 37%, about 5 to about 36%, about 5 to about 35%, about 5 to about 34%, about 5 to about 33%, about 5 to about 32%, about 5 to about 31%, about 5 to about 30%, about 5 to about 29%, about 5 to about 28%, about 5 to about 27%, about 5 to about 26%, about 5 to about 25%, about 5 to about 24%, about 5 to about 23%, about 5 to about 22%, about 5 to about 21%, about 5 to about 20%, about 5 to about 19%, about 5 to about 18%, about 5 to about 17%, about 5 to about 16%, about 5 to about 15%, about 5 to about 14%, about 5 to about 13%, about 5 to about 12%, about 5 to about 11%, about 5 to about 10%, about 5 to about 9%, about 5 to about 8%, about 5 to about 7%, about 5 to about 6%, about 6 to about 50%, about 7 to about 50%, about 8 to about 50%, about 9 to about 50%, about 10 to about 50%, about 11 to about 50%, about 12 to about 50%, about 13 to about 50%, about 14 to about 50%, about 15 to about 50%, about 16 to about 50%, about 17 to about 50%, about 18 to about 50%, about 19 to about 50%, about 20 to about 50%, about 21 to about 50%, about 22 to about 50%, about 23 to about 50%, about 24 to about 50%, about 25 to about 50%, about 26 to about 50%, about 27 to about 50%, about 28 to about 50%, about 29 to about 50%, about 30 to about 50%, about 31 to about 50%, about 32 to about 50%, about 33 to about 50%, about 34 to about 50%, about 35 to about 50%, about 36 to about 50%, about 37 to about 50%, about 38 to about 50%, about 39 to about 50%, about 40 to about 50%, about 41 to about 50%, about 42 to about 50%, about 43 to about 50%, about 44 to about 50%, about 45 to about 50%, about 46 to about 50%, about 47 to about 50%, about 48 to about 50%, about 49 to about 50%, about 6 to about 48%, about 6 to about 46%, about 7 to about 46%, about 7 to about 44%, about 8 to about 44%, about 8 to about 42%, about 9 to about 42%, about 9 to about 40%, about 10 to about 40%, about 10 to about 38%, about 11 to about 38%, about 11 to about 36%, about 12 to about 36%, about 12 to about 34%, about 13 to about 34%, about 13 to about 32%, about 14 to about 32%, about 14 to about 30%, about 15 to about 30%, about 15 to about 28%, about 16 to about 28%, about 16 to about 26%, about 17 to about 26%, about 17 to about 24%, about 18 to about 24%, about 18 to about 22%, about 19 to about 22%, about 19 to about 20%, about 10 to about 20%, about 10 to about 19%, about 11 to about 19%, about 11 to about 18%, about 12 to about 18%, about 12 to about 17%, about 13 to about 17%, about 13 to about 16%, about 14 to about 16%, about 14 to about 15%, about 15 to about 25%, about 15 to about 24%, about 16 to about 24%, about 16 to about 23%, about 17 to about 23%, about 17 to about 22%, about 18 to about 22%, about 18 to about 21%, about 19 to about 21%, about 19 to about 20%, about 60%, about 59%, about 58%, about 57%, about 56%, about 55%, about 54%, about 53%, about 52%, about 51%, about 50%, about 49%, about 48%, about 47%, about 46%, about 45%, about 44%, about 43%, about 42%, about 41%, about 40%, about 39%, about 38%, about 37%, about 36%, about 35%, about 34%, about 33%, about 32%, about 31%, about 30%, about 29%, about 28%, about 27%, about 26%, about 25%, about 24%, about 23%, about 22%, about 21%, about 20%, about 19%, about 18%, about 17%, about 16%, about 15%, about 14%, about 13%, about 12%, about 11%, about 10%, about 9%, about 8%, about 7%, about 6%, or about 5% of the tissue clearing composition. In some forms, the foregoing percentage values refer to w/v %.

In some forms, the water-soluble adjusting agent can be about 5 to about 60%, about 5 to about 59%, about 5 to about 58%, about 5 to about 57%, about 5 to about 56%, about 5 to about 55%, about 5 to about 54%, about 5 to about 53%, about 5 to about 52%, about 5 to about 51%, about 5 to about 50%, about 5 to about 49%, about 5 to about 48%, about 5 to about 47%, about 5 to about 46%, about 5 to about 45%, about 5 to about 44%, about 5 to about 43%, about 5 to about 42%, about 5 to about 41%, about 5 to about 40%, about 5 to about 39%, about 5 to about 38%, about 5 to about 37%, about 5 to about 36%, about 5 to about 35%, about 5 to about 34%, about 5 to about 33%, about 5 to about 32%, about 5 to about 31%, about 5 to about 30%, about 5 to about 29%, about 5 to about 28%, about 5 to about 27%, about 5 to about 26%, about 5 to about 25%, about 5 to about 24%, about 5 to about 23%, about 5 to about 22%, about 5 to about 21%, about 5 to about 20%, about 5 to about 19%, about 5 to about 18%, about 5 to about 17%, about 5 to about 16%, about 5 to about 15%, about 5 to about 14%, about 5 to about 13%, about 5 to about 12%, about 5 to about 11%, about 5 to about 10%, about 5 to about 9%, about 5 to about 8%, about 5 to about 7%, about 5 to about 6%, about 6 to about 50%, about 7 to about 50%, about 8 to about 50%, about 9 to about 50%, about 10 to about 50%, about 11 to about 50%, about 12 to about 50%, about 13 to about 50%, about 14 to about 50%, about 15 to about 50%, about 16 to about 50%, about 17 to about 50%, about 18 to about 50%, about 19 to about 50%, about 20 to about 50%, about 21 to about 50%, about 22 to about 50%, about 23 to about 50%, about 24 to about 50%, about 25 to about 50%, about 26 to about 50%, about 27 to about 50%, about 28 to about 50%, about 29 to about 50%, about 30 to about 50%, about 31 to about 50%, about 32 to about 50%, about 33 to about 50%, about 34 to about 50%, about 35 to about 50%, about 36 to about 50%, about 37 to about 50%, about 38 to about 50%, about 39 to about 50%, about 40 to about 50%, about 41 to about 50%, about 42 to about 50%, about 43 to about 50%, about 44 to about 50%, about 45 to about 50%, about 46 to about 50%, about 47 to about 50%, about 48 to about 50%, about 49 to about 50%, about 6 to about 48%, about 6 to about 46%, about 7 to about 46%, about 7 to about 44%, about 8 to about 44%, about 8 to about 42%, about 9 to about 42%, about 9 to about 40%, about 10 to about 40%, about 10 to about 38%, about 11 to about 38%, about 11 to about 36%, about 12 to about 36%, about 12 to about 34%, about 13 to about 34%, about 13 to about 32%, about 14 to about 32%, about 14 to about 30%, about 15 to about 30%, about 15 to about 28%, about 16 to about 28%, about 16 to about 26%, about 17 to about 26%, about 17 to about 24%, about 18 to about 24%, about 18 to about 22%, about 19 to about 22%, about 19 to about 20%, about 10 to about 20%, about 10 to about 19%, about 11 to about 19%, about 11 to about 18%, about 12 to about 18%, about 12 to about 17%, about 13 to about 17%, about 13 to about 16%, about 14 to about 16%, about 14 to about 15%, about 15 to about 25%, about 15 to about 24%, about 16 to about 24%, about 16 to about 23%, about 17 to about 23%, about 17 to about 22%, about 18 to about 22%, about 18 to about 21%, about 19 to about 21%, about 19 to about 20%, about 60%, about 59%, about 58%, about 57%, about 56%, about 55%, about 54%, about 53%, about 52%, about 51%, about 50%, about 49%, about 48%, about 47%, about 46%, about 45%, about 44%, about 43%, about 42%, about 41%, about 40%, about 39%, about 38%, about 37%, about 36%, about 35%, about 34%, about 33%, about 32%, about 31%, about 30%, about 29%, about 28%, about 27%, about 26%, about 25%, about 24%, about 23%, about 22%, about 21%, about 20%, about 19%, about 18%, about 17%, about 16%, about 15%, about 14%, about 13%, about 12%, about 11%, about 10%, about 9%, about 8%, about 7%, about 6%, or about 5% of the tissue clearing composition. In some forms, the foregoing percentage values refer to w/v %.

In some forms, the lipid-soluble adjusting agent can be about 5 to about 70%, about 5 to about 69%, about 5 to about 68%, about 5 to about 67%, about 5 to about 66%, about 5 to about 65%, about 5 to about 64%, about 5 to about 63%, about 5 to about 62%, about 5 to about 61%, about 5 to about 60%, about 5 to about 59%, about 5 to about 58%, about 5 to about 57%, about 5 to about 56%, about 5 to about 55%, about 5 to about 54%, about 5 to about 53%, about 5 to about 52%, about 5 to about 51%, about 5 to about 50%, about 5 to about 49%, about 5 to about 48%, about 5 to about 47%, about 5 to about 46%, about 5 to about 45%, about 5 to about 44%, about 5 to about 43%, about 5 to about 42%, about 5 to about 41%, about 5 to about 40%, about 5 to about 39%, about 5 to about 38%, about 5 to about 37%, about 5 to about 36%, about 5 to about 35%, about 5 to about 34%, about 5 to about 33%, about 5 to about 32%, about 5 to about 31%, about 5 to about 30%, about 5 to about 29%, about 5 to about 28%, about 5 to about 27%, about 5 to about 26%, about 5 to about 25%, about 5 to about 24%, about 5 to about 23%, about 5 to about 22%, about 5 to about 21%, about 5 to about 20%, about 5 to about 19%, about 5 to about 18%, about 5 to about 17%, about 5 to about 16%, about 5 to about 15%, about 5 to about 14%, about 5 to about 13%, about 5 to about 12%, about 5 to about 11%, about 5 to about 10%, about 5 to about 9%, 5 about to about 8%, about 5 to about 7%, about 5 to about 6%, about 6 to about 60%, about 7 to about 60%, about 8 to about 60%, about 9 to about 60%, about 10 to about 60%, about 11 to about 60%, about 12 to about 60%, about 13 to about 60%, about 14 to about 60%, about 15 to about 60%, about 16 to about 60%, about 17 to about 60%, about 18 to about 60%, about 19 to about 60%, about 20 to about 60%, about 21 to about 60%, about 22 to about 60%, about 23 to about 60%, about 24 to about 60%, about 25 to about 60%, about 26 to about 60%, about 27 to about 60%, about 28 to about 60%, about 29 to about 60%, about 30 to about 60%, about 31 to about 60%, about 32 to about 60%, about 33 to about 60%, about 34 to about 60%, about 35 to about 60%, about 36 to about 60%, about 37 to about 60%, about 38 to about 60%, about 39 to about 60%, about 40 to about 60%, about 41 to about 60%, about 42 to about 60%, about 43 to about 60%, about 44 to about 60%, about 45 to about 60%, about 46 to about 60%, about 47 to about 60%, about 48 to about 60%, about 49 to about 60%, about 16 to about 44%, about 16 to about 43%, about 17 to about 43%, about 17 to about 42%, about 18 to about 42%, about 18 to about 41%, about 19 to about 41%, about 19 to about 40%, about 20 to about 40%, about 20 to about 39%, about 21 to about 39%, about 21 to about 38%, about 22 to about 38%, about 22 to about 37%, about 23 to about 37%, about 23 to about 36%, about 24 to about 36%, about 24 to about 35%, about 25 to about 35%, about 25 to about 34%, about 26 to about 34%, about 26 to about 33%, about 27 to about 33%, about 27 to about 32%, about 28 to about 32%, about 28 to about 31%, about 29 to about 31%, about 29 to about 30%, about 25 to about 35%, about 25 to about 34%, about 26 to about 34%, about 26 to about 33%, about 27 to about 33%, about 27 to about 32%, about 28 to about 32%, about 28 to about 31%, about 29 to about 31%, about 29 to about 30%, about 20 to about 30%, about 20 to about 29%, about 21 to about 29%, about 21 to about 28%, about 22 to about 28%, about 22 to about 27%, about 23 to about 27%, about 23 to about 26%, about 24 to about 26%, about 24 to about 25%, about 70%, about 69%, about 68%, about 67%, about 66%, about 65%, about 64%, about 63%, about 62%, about 61%, about 60%, about 59%, about 58%, about 57%, about 56%, about 55%, about 54%, about 53%, about 52%, about 51%, about 50%, about 49%, about 48%, about 47%, about 46%, about 45%, about 44%, about 43%, about 42%, about 41%, about 40%, about 39%, about 38%, about 37%, about 36%, about 35%, about 34%, about 33%, about 32%, about 31%, about 30%, about 29%, about 28%, about 27%, about 26%, about 25%, about 24%, about 23%, about 22%, about 21%, about 20%, about 19%, about 18%, about 17%, about 16%, about 15%, about 14%, about 13%, about 12%, about 11%, about 10%, about 9%, about 8%, about 7%, about 6%, or about 5% of the tissue clearing composition. In some forms, the foregoing percentage values refer to w/v %.

In some forms, the molar ratio of the homogenizing agent to the borate compound is between about 0.5 and about 2, between about 0.5 and about 1.9, between about 0.5 and about 1.8, between about 0.5 and about 1.7, between about 0.5 and about 1.6, between about 0.5 and about 1.5, between about 0.5 and about 1.4, between about 0.5 and about 1.3, between about 0.5 and about 1.2, between about 0.5 and about 1.1, between about 0.5 and about 1, between about 0.6 and about 2, between about 0.6 and about 1.9, between about 0.6 and about 1.8, between about 0.6 and about 1.7, between about 0.6 and about 1.6, between about 0.6 and about 1.5, between about 0.6 and about 1.4, between about 0.6 and about 1.3, between about 0.6 and about 1.2, between about 0.6 and about 1.1, between about 0.6 and about 1, between about 0.7 and about 2, between about 0.7 and about 1.9, between about 0.7 and about 1.8, between about 0.7 and about 1.7, between about 0.7 and about 1.6, between about 0.7 and about 1.5, between about 0.7 and about 1.4, between about 0.7 and about 1.3, between about 0.7 and about 1.2, between about 0.7 and about 1.1, between about 0.7 and about 1, between about 0.8 and about 2, between about 0.8 and about 1.9, between about 0.8 and about 1.8, between about 0.8 and about 1.7, between about 0.8 and about 1.6, between about 0.8 and about 1.5, between about 0.8 and about 1.4, between about 0.8 and about 1.3, between about 0.8 and about 1.2, between about 0.8 and about 1.1, between about 0.8 and about 1, between about 0.9 and about 2, between about 0.9 and about 1.9, between about 0.9 and about 1.8, between about 0.9 and about 1.7, between about 0.9 and about 1.6, between about 0.9 and about 1.5, between about 0.9 and about 1.4, between about 0.9 and about 1.3, between about 0.9 and about 1.2, between about 0.9 and about 1.1, between about 0.9 and about 1, between about 1 and about 2, between about 1 and about 1.9, between about 1 and about 1.8, between about 1 and about 1.7, between about 1 and about 1.6, between about 1 and about 1.5, between about 1 and about 1.4, between about 1 and about 1.3, between about 1 and about 1.2, between about 1 and about 1.1, about 0.5, about 0.6, about 0.7, about 0.8, about 0.9, about 1, about 1.1, about 1.2, about 1.3, about 1.4, about 1.5, about 1.6, about 1.7, about 1.8, about 1.9, or about 2.

In some forms, the disclosed tissue clearing compositions include N-methylglucamine, iohexol, and 2,2′-thiodiethanol, with the concentration of each of these components ranging from about 10 to about 50 w/v %. Preferably, the tissue clearing composition can be composed of about 20 w/v % N-methylglucamine, about 32 w/v % iohexol, and about 25 w/v % thiodiethanol.

In some forms, the disclosed tissue clearing compositions include N-methylglucamine, iohexol, and propylene glycol, with the concentration of each of N-methylglucamine and iohexol ranging from about 10 to about 50 w/v % and the concentration of propylene glycol ranging from about 10 to about 60 w/v %. Preferably, the tissue clearing composition can be composed of about 20 w/v % N-methylglucamine, about 32 w/v % iohexol, and about 35 w/v % propylene glycol.

In some forms, the disclosed tissue clearing compositions include urea, iohexol, and 2,2′-thiodiethanol, with the concentration of urea ranging from about 5 to about 50 w/v %, and the concentration of each of iohexol and 2,2′-thiodiethanol ranging from about 10 to about 50 w/v %. Preferably, the tissue clearing composition can be composed of about 10 w/v % urea, about 32 w/v % iohexol, and about 25 w/v % 2,2′-thiodiethanol.

In some forms, the disclosed tissue clearing compositions include N-methylglucamine, iohexol, 2,2′-thiodiethanol, and boric acid, with the concentration of each of N-methylglucamine, iohexol, and 2,2′-thiodiethanol ranging from about 10 to about 50 w/v % and the molar ratio of N-methylglucamine to boric acid between about 0.5 and about 2. Preferably, the tissue clearing composition can be composed of about 20 w/v % N-methylglucamine, about 32 w/v % iohexol, and about 25 w/v % thiodiethanol, with the molar ratio of N-methylglucamine to boric acid at about 1.

In some forms, the disclosed tissue clearing compositions include N-methylglucamine, iohexol, propylene glycol and boric acid, with the concentration of each of N-methylglucamine and iohexol ranging from about 10 to about 50 w/v %, the concentration of propylene glycol ranging from about 10 to about 60 w/v %, and the molar ratio of N-methylglucamine to boric acid between about 0.5 and about 2. Preferably, the tissue clearing composition can be composed of about 20 w/v % N-methylglucamine, about 32 w/v % iohexol, and about 35 w/v % propylene glycol, with molar ratio of N-methylglucamine to boric acid at about 1.

In some forms, the disclosed tissue clearing compositions include urea, iohexol, 2,2′-thiodiethanol, and boric acid, with the concentration of urea ranging from about 5 to about 50 w/v %, the concentration of each of iohexol and 2,2′-thiodiethanol ranging from about 10 to about 50 w/v %, and the molar ratio of urea to boric acid between 0.5 and 2. Preferably, the tissue clearing composition can be composed of about 10 w/v % urea, about 32 w/v % iohexol, and about 25 w/v % 2,2′-thiodiethanol, with the molar ratio of urea to boric acid at about 1.

However, as may be understood by those of skill in the art, the components, ranges and subranges of concentrations of any such components may vary depending on the particular application of the tissue clearing composition.

In some forms, the compositions are suitable for robust, general applications. In some forms, the compositions are suitable for use with fresh tissues. In some forms, the compositions are suitable for use with long-fixed tissues. In some forms, the compositions are suitable for in vivo clearing applications.

In some forms, the disclosed tissue clearing compositions are compatible with, for example, further processing methods for histology and electron microscopy studies, other tissue clearing methods, different tissue staining methods (such as immunohistochemistry, chemical staining, transgenic cell labelling methods, imaging probes, tissue in situ chemistry, and viral tracing methods), or combinations thereof.

Separate forms of tissue clearing compositions can be formulated and used for different tissues and source species. In some forms, the compositions are suitable for clearing non-neural, non-osseous tissues or organs. In some forms, the non-neural, non-osseous tissues or organs are non-neural, non-osseous solid organs such as the heart, kidney, liver, lungs, and pancreas. In some forms, the non-neural, non-osseous solid organ is kidney. In some forms, the non-neural, non-osseous tissues or organs are non-neural, non-osseous pathological tissues or organs, such as tumor tissues.

In some forms, the compositions are suitable for clearing plant tissues, animal tissues or organs, or both. In some forms, the compositions are suitable for clearing mammalian tissues or organs. In some forms, the compositions are suitable for clearing human tissues or organs.

In some forms, the compositions are suitable for clearing tissues retrieved from archived sources. In some forms, the compositions are suitable for clearing tissues that have been archived for anywhere between about 3 months and about 50 years. In some forms, the compositions are suitable for clearing tissues that were recently fixed, such as anywhere between about 3 weeks to about 3 months.

In some forms, the tissue to be cleared can be archived tissue, where the archived tissue has been stored for at least 3 weeks, 4 weeks, 1 month, 5 weeks, 6 weeks, 7 weeks, 8 weeks, 2 months, 9 weeks, 10 weeks, 11 weeks, 12 weeks, 13 weeks, 3 months, 14 weeks, 15 weeks, 16 weeks, 17 weeks, 4 months, 18 weeks, 19, weeks, 20 weeks, 21 weeks, 5 months, 22 weeks, 23 weeks, 24 weeks, 25 weeks, 26 weeks, 6 months, 27 weeks, 28 weeks, 29 weeks, 30 weeks, 7 months, 31 weeks, 32, weeks, 33 weeks, 34 weeks, 8 months, 35 weeks, 36 weeks, 37 weeks, 38 weeks, 39 weeks, 9 months, 40 weeks, 41 weeks, 42 weeks, 43 weeks, 10 months, 44 weeks, 45 weeks, 46 weeks, 47 weeks, 11 months, 48 weeks, 49 weeks, 50 weeks, 51 weeks, 52 weeks, 12 months, 1 year, 13 months, 14 months, 15 months, 16 months, 17 months, 18 months, 19 months, 20 months, 21 months, 22 months, 23 months, 24 months, 2 years, 30 months, 36 months, 3 years, 42 months, 48 months, 4 years, 54 months, 60 months, 5 years, 6 year, 7 years, 8 years, 9 years, 10 years, 11 years, 12 years, 13 years, 14 years, 15 years, 16 years, 17, years, 18 years, 19 years, 20 years, 22 year, 24 years, 25 years, 26 years, 28 years, 30 years, 35 years, 40 years, or 50 years.

However, as will be understood by one of skill in the art, the timeframe for tissue fixation prior to application of the disclosed tissue clearing compositions may vary, and, as such, is not limited to above identified timeframes.

It is also to be understood that use of the compositions disclosed herein is not limited to above identified tissues, sources, or source species, and, as such, may vary.

### III. Kits

The disclosed tissue clearing compositions, as well as other materials can be packaged together in any suitable combination as a kit useful for performing, or aiding in the performance of, the disclosed method. It is useful if the kit components in a given kit are designed and adapted for use together in the disclosed method.

The disclosed compositions can include additional components that, for example, make the composition useful or tailored for specific tissues and source species to which it is to be applied.

In some forms, the disclosed tissue clearing compositions in the kits are composed of four core components; (1) a homogenizing agent, (2) a water-soluble adjusting agent, (3) a lipid-soluble adjusting agent, and (4) a borate compound.

In some forms, the tissue clearing kit can include a composition having about 20 w/v % N-methylglucamine, about 32 w/v % iohexol, and about 25 w/v % thiodiethanol, with the molar ratio of N-methylglucamine to boric acid at about 1. In some forms, the kit can include a composition having about 20 w/v % N-methylglucamine, about 32 w/v % iohexol, and about 35 w/v % propylene glycol, with molar ratio of N-methylglucamine to boric acid at about 1. In some forms, the kit can include a composition having about 10 w/v % urea, about 32 w/v % iohexol, and about 25 w/v % 2,2′-thiodiethanol, with the molar ratio of urea to boric acid at about 1.

However, as will be understood by those of skill in the art, the components, ranges and subranges of concentrations of any such components in a particular kit may vary depending on the particular application of the tissue clearing composition.

Separate forms of tissue clearing compositions in the kits can be formulated and used for different tissues and source species. In some forms, the compositions are suitable for clearing non-neural, non-osseous tissues or organs. In some forms, the non-neural, non-osseous tissues or organs are non-neural, non-osseous solid organs such as the heart, kidney, liver, lungs, and pancreas. In some form, the non-neural, non-osseous solid organ is kidney. In some forms, the non-neural, non-osseous tissues or organs are non-neural, non-osseous pathological tissues or organs, such as tumor tissues.

In some forms, the compositions are suitable for clearing plant tissues, animal tissues or organs, or both. In some forms, the compositions are suitable for clearing mammalian tissues or organs. In some forms, the compositions are suitable for clearing human tissues or organs.

In some forms, the compositions are suitable for clearing tissues retrieved from archived sources. In some forms, the compositions are suitable for clearing tissues that have been archived for anywhere between about 3 months and about 50 years. In some forms, the compositions are suitable for clearing tissues that were recently fixed, such as anywhere between about 3 weeks to about 3 months.

In some forms, the disclosed kits can also include a liquid carrier. In some forms, the liquid carrier is an aqueous solution. In some forms, the aqueous solution is a concentrate, such as a 5×, 10×, or 20× concentrate. In some forms, the aqueous solution contains one or more of the following: sodium azide (optionally at a concentration of about 10% w/v); a surfactant such as Triton X-100 or sodium dodecyl sulphate (optionally at a concentration of between about 4 and about 8 w/v %); and a buffering agent such as a borate compound (e.g., boric acid, optionally at a concentration of 0.05-0.5 M and optionally with the buffer pH between about 8 and about 9) or the buffering agents for phosphate-buffered saline.

In some forms, the disclosed kits can also include 10% w/v sodium azide solution, 10× concentrate of P, phosphate-buffered saline with 0.1% Triton X-100 and 0.01% sodium azide, 4% w/v sodium dodecyl sulphate in 0.2 M sodium borate buffer at pH 8.5, or 8% w/v sodium dodecyl sulphate in phosphate-buffered saline at pH 7.4.

### IV. Methods of Using

Disclosed are also methods of clearing a tissue sample using the tissue clearing compositions. The methods include incubating the tissue sample with a tissue clearing composition. The incubation time can range from about 3 hours to about 24 hours. The incubation temperature can range from about 37° C. to about 55° C.

The methods can also include the steps of, prior to incubating the tissue sample: (a) selecting a homogenizing agent, a water-soluble adjusting agent, a lipid-soluble adjusting agent, and a borate compound and (b) mixing the homogenizing agent, water-soluble adjusting agent, lipid-soluble adjusting agent, and borate compound to form the tissue clearing composition.

The methods can be coupled with, before or after incubating the tissue sample, one or more of detection and/or characterization steps, such as:

(i) staining the tissue sample using one or more fluorescent dyes;

(ii) imaging one or more fluorescent proteins expressed in the tissue sample;

(iii) performing immunohistochemistry, fluorescent histochemistry, or both on the tissue sample; and

(iv) characterizing the tissue sample using transmission electron microscopy.

In some forms, the methods can be used together with other tissue clearing methods.

The disclosed methods of clearing the tissue sample are useful for 3D histology. Histology is the study of tissue microanatomy, there exists many approaches to visualize tissues in 3D, tissue clearing is one of them that has the unique advantage of leaving the tissue intact for subsequent optical sectioning of the transparent sample, contrast to other methods where 3D histology requires physically sectioning the sample into many thin slices with subsequent computerized reconstruction.

A. RI Homogenization with the Tissue Clearing Composition

The present disclosure also encompasses a method for rendering a biomaterial of a subject transparent. In some forms, the method can include the single step of incubating a tissue sample in a suitable tissue clearing composition as described herein at a particular temperature for a sufficient period of time. Incubation may occur at a temperature ranging from about 37° C. to about 55° C. for a time period ranging from about 3 hours to about 24 hours. Preferably, the sample is incubated in the tissue clearing composition for about 6 hours at about 37° C.

In some forms, the tissue sample is incubated in a tissue clearing composition that includes N-methylglucamine, iohexol, 2,2′-thiodiethanol, and boric acid, with the concentration of each of N-methylglucamine, iohexol, and 2,2′-thiodiethanol ranging from about 10 to about 50 w/v % and the molar ratio of N-methylglucamine to boric acid between about 0.5 and about 2. Preferably, the tissue sample is incubated in a tissue clearing composition containing about 20 w/v % N-methylglucamine, about 32 w/v % iohexol, and about 25 w/v % thiodiethanol, with the molar ratio of N-methylglucamine to boric acid at about 1.

In other forms, the tissue sample is incubated in a tissue clearing composition that includes N-methylglucamine, iohexol, propylene glycol and boric acid, with the concentration of each of N-methylglucamine and iohexol ranging from about 10 to about 50 w/v %, the concentration of propylene glycol ranging from about 10 to about 60 w/v %, and the molar ratio of N-methylglucamine to boric acid between about 0.5 and about 2. Preferably, the tissue sample is incubated in a tissue clearing composition containing about 20 w/v % N-methylglucamine, about 32 w/v % iohexol, and about 35 w/v % propylene glycol, with molar ratio of N-methylglucamine to boric acid at about 1.

In still other forms, the tissue sample is incubated in a tissue clearing composition that includes urea, iohexol, 2,2′-thiodiethanol, and boric acid, with the concentration of urea ranging from about 5 to about 50 w/v %, the concentration of each of iohexol and 2,2′-thiodiethanol ranging from about 10 to about 50 w/v %, and the molar ratio of urea to boric acid between 0.5 and 2. Preferably, the tissue sample is incubated in a tissue clearing composition containing about 10 w/v % urea, about 32 w/v % iohexol, and about 25 w/v % 2,2′-thiodiethanol, with the molar ratio of urea to boric acid at about 1.

However, as may be understood by those of skill in the art, the tissue sample may be incubated in compositions whose components, ranges and subranges of concentrations of any such components vary depending on the tissue and particular application. The tissue sample may be a tissue or an organ of a plant or an animal, preferably a tissue or an organ of an animal, such as insects, fishes, amphibians, birds, and mammals; and more preferably, a tissue or an organ of a mammal. The mammal may include but is not limited to, laboratory animals such as mice, rats, rabbits, guinea pigs, and primates; pet animals such as dogs and cats; farm animals such as cows, horses, sheep; and humans. Preferably, the tissue or organ is derived from a human or a mouse. Most preferably, the tissue or organ is derived from a human.

In some forms, the tissue sample is from a non-neural, non-osseous tissue or organ. In some forms, the tissue sample is from a non-neural, non-osseous solid organ such as the heart, kidney, liver, lungs, and pancreas. Preferably, the non-neural, non-osseous solid organ is kidney. In some forms, the tissue sample is a renal tissue sample. In some forms, the tissue sample is a pathological tissue sample, such as a tumor tissue sample. In some forms, the tissue sample is not from a neural tissue or organ. In some forms, the tissue sample is not a brain tissue sample.

The tissue sample can be fresh, archived, or retrieved from a paraffin-embedded tissue.

B. Tissue Staining and Processing with the Tissue Clearing Composition

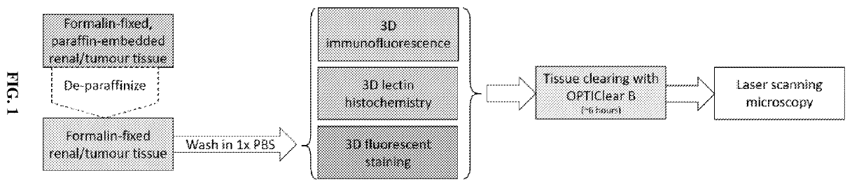

The tissue sample may be pre-labeled with an imaging tracer that is either a dye, a fluorescent protein, or an antibody, so that the imaging tracer may be traced under a microscope, preferably by a confocal microscope, after the sample tissue is subjected to clear treatment and becomes transparent. An exemplary protocol for tissue staining and processing is illustrated in FIG. 1.

In some forms, animal tissues such as human, rodent, and mouse tissues that are chemically fixed with formalin, or that are formalin-fixed, paraffin-embedded (FFPE), can be retrieved and subjected to various processing steps such as by rehydration through a series of organic solvents and washing methods, and preparation for subsequent “SDS Treatment.” SDS-treatment involves the partial delipidation of the prepared tissue for subsequent labelling. This can be achieved by immersing the prepared tissue into 4% or 8% SDS in a certain buffer, followed by incubation at a certain temperature, allowing for permeabilization and partial delipidation of the tissue.

In some forms, the retrieved archived tissue is subjected to lipophilic dye tracing. DiI and CM-DiI dyes may be directly applied to non-SDS treated kidney tissues (such as human or rodent kidney tissues) that have been fixed with formalin for ≥1 year. Tissues can subsequently be cleared with the tissue clearing composition and visualized in 3D using various imaging methods, such as by differential interference contrast, confocal microscopy, light sheet microscopy, ultramicroscopy, stochastic optical reconstruction microscopy, photoactivated localization microscopy, structured illumination microscopy, ground state depletion microscopy, stimulated emission depletion microscopy, scanning electron microscopy, transmission electron microscopy, wide-field fluorescence microscopy, conventional transmitted light microscopy, dissecting microscopy, spectrophotometry, fluorescence plate detection and fluorescence chip detection, etc.

In other forms, the retrieved archived tissue is subjected to chemical staining. These chemical stains may include but are necessarily limited to Dil staining, DAPI staining, or Lycopersicon esculentum lectin staining. The chemical stains may also include using fluorophore-labelled antibodies (such as antibodies specific for AQP2) to detect specific biomolecules in the tissue.

Dil staining uses Dil, a lipophilic tracer for lipids. DAPI staining uses DAPI, a nucleic acid stain. Lycopersicon esculentum lectin staining can be used to perform lectin histochemistry for detecting glycosylations; it targets various tubule types.

In other forms, the retrieved archived tissue is subjected to immunostaining using any suitable antibodies, such as antibodies that target AQP2, which can be used to visualize distal convoluted tubules in kidneys. In some forms, antibodies may be applied in high dilutions in a sequential manner, allowing them to penetrate further into the tissue. In other forms, antibodies may be applied in low dilutions in a single step in addition to a binding kinetics controller, facilitating its penetration into the tissue. In some forms, immunostaining techniques may be applied with or without signal amplification techniques. In some forms, immunostaining techniques may be done in conjunction with other preparation processes, as well as subsequent methodologies.

C. Applications

In some forms, the disclosed methods are applicable to plants. Preferably the disclosed methods are applicable to a tissue or an organ of an animal, such as insects, fishes, amphibians, birds, and mammals; and more preferably, a tissue or an organ of a mammal. The mammal may include but is not limited to, laboratory animals such as mice, rats, rabbits, guinea pigs, and primates; pet animals such as dogs and cats; farm animals such as cows, horses, sheep; and humans. Preferably, the tissue or organ is derived from a human. In some forms, the tissue sample is from a non-neural, non-osseous tissue or organ. In some forms, the tissue sample is from a non-neural, non-osseous solid organ such as the heart, kidney, liver, lungs, and pancreas. Preferably, the non-neural, non-osseous solid organ is kidney. In some forms, the tissue sample is a renal tissue sample. In some forms, the tissue sample is a pathological tissue sample, such as a tumor tissue sample. In some forms, the tissue sample is not from a neural tissue or organ. In some forms, the tissue sample is not a brain tissue sample.

In some forms, the disclosed methods are applicable to clinicopathological studies as well as trials for routine clinical use for improved patient diagnoses of diseases, such as cancer and renal diseases.

The disclosed compositions and methods can be further understood through the following numbered paragraphs.

1. A tissue clearing composition comprising a homogenizing agent, a water-soluble adjusting agent, a lipid-soluble adjusting agent, and a borate compound.

2. The tissue clearing composition of paragraph 1, wherein the borate compound is a hydrogen or metal borate in an anhydrous or hydrous form.

3. The tissue clearing composition of paragraph 1 or 2, wherein the borate compound is a hydrogen borate selected from the group consisting of boric acid (H₃BO₃), metaboric acid (H₃B₃O₆), and tetraboric acid (H₂B₄O₇).

4. The tissue clearing composition of any one of paragraphs 1 or 2, wherein the borate compound is a metal borate having a boron-containing oxyanion selected from the group consisting of metaborates (BO₂⁻), diborate (B₂O₅⁴⁻), triborate (B₃O₇⁵⁻), tetraborate (B₄O₇²⁻, B₄O₅(OH)₄²⁻, B₄O₉⁶⁻, or combinations thereof), and hydroxyborate (B(OH)₄⁻).

5. The tissue clearing composition of any one of paragraphs 1-4, wherein the borate compound is selected from the group consisting of boric acid, tetraboric acid, disodium tetraborate, and derivatives thereof.

6. The tissue clearing composition of any one of paragraphs 1-5, wherein the molar ratio of the homogenizing agent to the borate compound is between about 0.5 and about 2.

7. The tissue clearing composition of any one of paragraphs 1-6, wherein the molar ratio of the homogenizing agent to the borate compound is about 1.

8. The tissue clearing composition of any one of paragraphs 1-7, wherein the homogenizing agent is a denaturant of proteins, nucleic acids, or a combination thereof.

9. The tissue clearing composition of any one of paragraphs 1-8, wherein the homogenizing agent is a chaotropic agent.

10. The tissue clearing composition of any one of paragraphs 1-9, wherein the homogenizing agent is selected from the group consisting of N-methylglucamine, urea, thiourea, guanidine, guanidinium chloride, lithium perchlorate, ethylenediamine, triethanolamine, triethylamine, tetraethylammonium, and derivatives thereof.

11. The tissue clearing composition of any one of paragraphs 1-10, wherein the concentration of the homogenizing agent is between about 5 and about 60 w/v % or between about 10 and about 50 w/v %.

12. The tissue clearing composition of any one of paragraphs 1-11, wherein the water-soluble and lipid-soluble adjusting agents are refractive index adjusting agents.

13. The tissue clearing composition of any one of paragraphs 1-12, wherein the water-soluble adjusting agent, the lipid-soluble adjusting agent, or both have a refractive index higher than that of water at 25° C.

14. The tissue clearing composition of any one of paragraphs 1-13, wherein the water-soluble adjusting agent, the lipid-soluble adjusting agent, or both have a refractive index between about 1.40 and about 1.50 at 25° C.

15. The tissue clearing composition of any one of paragraphs 1-14, wherein the refractive index of the water-soluble adjusting agent is at or within 10% of the refractive index of the lipid-soluble adjusting agent at 25° C.

16. The tissue clearing composition of any one of paragraphs 1-15, wherein the water-soluble adjusting agent is selected from the group consisting of iohexol, sodium thiosulfate, polyethylene glycol, ethylene carbonate, and derivatives thereof.

17. The tissue clearing composition of any one of paragraphs 1-16, wherein the concentration of the water-soluble adjusting agent is between about 5 and about 60 w/v % or between about 10 and about 50 w/v %.

18. The tissue clearing composition of any one of paragraphs 1-17, wherein the lipid-soluble adjusting agent is miscible with water.

19. The tissue clearing composition of any one of paragraphs 1-18, wherein the lipid-soluble adjusting agent is selected from the group consisting of 2,2′-thiodiethanol, propylene glycol, ethylene carbonate, and derivatives thereof.

20. The tissue clearing composition of any one of paragraphs 1-19, wherein the concentration of the lipid-soluble adjusting agent is between about 5 and about 70 w/v % or between about 10 and about 50 w/v %.

21. The tissue clearing composition of paragraph 1, wherein

(a) the homogenizing agent is selected from the group consisting of N-methylglucamine, urea, thiourea, guanidine, guanidinium chloride, lithium perchlorate, ethylenediamine, and derivatives thereof;

(b) the water-soluble adjusting agent is selected from the group consisting of iohexol, sodium thiosulfate, polyethylene glycol, and derivatives thereof;

(c) the lipid-soluble adjusting agent is selected from the group consisting of 2,2′-thiodiethanol, propylene glycol, and derivatives thereof; and

(d) the borate compound is selected from the group consisting of boric acid, tetraboric acid, disodium tetraborate, and derivatives thereof.

22. The tissue clearing composition of paragraph 21, wherein the homogenizing agent is N-methylglucamine, the water-soluble adjusting agent is iohexol, the lipid-soluble adjusting agent is 2,2′-thiodiethanol, and the borate compound is boric acid.

23. The tissue clearing composition of paragraph 22, wherein the concentration of each of N-methylglucamine, iohexol, and 2,2′-thiodiethanol ranges from about 10 to about 50 w/v %, and the molar ratio of N-methylglucamine to boric acid is between about 0.5 and about 2.

24. The tissue clearing composition of paragraph 23, wherein the concentration of N-methylglucamine is about 20 w/v %, the concentration of iohexol is about 32 w/v %, the concentration of thiodiethanol is about 25 w/v %, and the molar ratio of N-methylglucamine to boric acid is about 1.

25. The tissue clearing composition of paragraph 21, wherein the homogenizing agent is N-methylglucamine, the water-soluble adjusting agent is iohexol, the lipid-soluble adjusting agent is propylene glycol, and the borate compound is boric acid.

26. The tissue clearing composition of paragraph 25, wherein the concentration of each of N-methylglucamine and iohexol ranges from about 10% to about 50%, the concentration of propylene glycol ranges from about 10 to about 60 w/v %, and the molar ratio of N-methylglucamine to boric acid is between about 0.5 and about 2.

27. The tissue clearing composition of paragraph 26, wherein the concentration of N-methylglucamine is about 20 w/v %, the concentration of iohexol is about 32 w/v %, the concentration of propylene glycol is about 35 w/v %, and the molar ratio of N-methylglucamine to boric acid is about 1.

28. The tissue clearing composition of paragraph 21, wherein the homogenizing agent is urea, the water-soluble adjusting agent is iohexol, the lipid-soluble adjusting agent is 2,2′-thiodiethanol, and the borate compound is boric acid.

29. The tissue clearing composition of paragraph 28, wherein the concentration of urea ranges from about 5 to about 50 w/v %, the concentration of each of iohexol and 2,2′-thiodiethanol ranges from about 10 to about 50 w/v %, and the molar ratio of urea to boric acid is between about 0.5 and about 2.

30. The tissue clearing composition of paragraph 29, wherein the concentration of urea is about 10 w/v %, the concentration of iohexol is about 32 w/v %, the concentration of 2,2′-thiodiethanol is about 25 w/v %, and the molar ratio of urea to boric acid is about 1.

31. The tissue clearing composition of any one of paragraphs 1-30, further comprising one or more excipients selected from liquid vehicles, dispersion or suspension aids, surfactants, isotonic agents, thickening or emulsifying agents, preservatives, solid binders, lubricants, and combinations thereof.

32. The tissue clearing composition of paragraph 31, wherein the liquid vehicles is selected from solvents, dispersion media, and diluents.

33. The tissue clearing composition of paragraph 32, wherein the diluents comprise aqueous media selected from water, acid solutions, and buffered solutions.

34. The tissue clearing composition of any one of paragraphs 31-33, wherein the isotonic agents comprise sodium chloride, potassium chloride, sodium lactate, calcium chloride, and glucose.

35. The tissue clearing composition of any one of paragraphs 1-34, wherein the tissue clearing composition has a refractive index between about 1.4 and about 1.5 at 25° C.

36. The tissue clearing composition of any one of paragraphs 1-35, wherein the tissue clearing composition has a pH in the range from about 5 to about 9, from about 5.5 to about 8.5, from about 6 to about 8, or from about 7 to about 10.

37. The tissue clearing composition of any one of paragraphs 1-36, wherein the tissue clearing composition shows improved tissue clearing capacity for non-neural, non-osseous tissues or organs relative to corresponding compositions without the borate compound, relative to corresponding compositions with the borate compound replaced by an organic or inorganic acid, or relative to both.

38. A method of clearing tissues comprising incubating a tissue sample in the tissue clearing composition of any one of paragraphs 1-37.

39. The method of paragraph 38, wherein the homogenizing agent is N-methylglucamine, the water-soluble adjusting agent is iohexol, the lipid-soluble adjusting agent is 2,2′-thiodiethanol, and the borate compound is boric acid.

40. The method of paragraph 39, wherein the concentration of each of N-methylglucamine, iohexol, and 2,2′-thiodiethanol ranges from about 10 to about 50 w/v %, and the molar ratio of N-methylglucamine to boric acid is between about 0.5 and about 2.

41. The method of paragraph 40, wherein the concentration of N-methylglucamine is about 20 w/v %, the concentration of iohexol is about 32 w/v %, the concentration of thiodiethanol is about 25 w/v %, and the molar ratio of N-methylglucamine to boric acid is about 1.

42. The method of any one of paragraphs 38-41, wherein the tissue sample is incubated for a period of time ranging from about 3 to about 24 hours at a temperature ranging from about 37 to about 55° C.

43. The method of any one of paragraphs 38-42, wherein the tissue sample is a mammalian tissue sample.

44. The method of any one of paragraphs 38-43, wherein the tissue sample is a human tissue sample.

45. The method of any one of paragraphs 38-44, wherein the tissue sample is from a non-neural, non-osseous tissue or organ.

46. The method of any one of paragraphs 38-45, wherein the tissue sample is from a non-neural, non-osseous solid organ.

47. The method of any one of paragraphs 38-46, wherein the tissue sample is a renal tissue sample.

48. The method of any one of paragraphs 38-47, wherein the tissue sample is a pathological tissue sample.

49. The method of any one of paragraphs 38-48, wherein the tissue sample is a tumor tissue sample.

50. The method of any one of paragraphs 38-49, wherein the tissue sample is not a brain tissue sample.

51. The method of any one of paragraphs 38-50, wherein the tissue sample is fresh, archived, or retrieved from a paraffin wax-embedded tissue.

52. The method of any one of paragraphs 38-51, further comprising, prior to incubating the tissue sample:

(a) selecting a homogenizing agent, a water-soluble adjusting agent, a lipid-soluble adjusting agent, and a borate compound; and

(b) mixing the homogenizing agent, water-soluble adjusting agent, lipid-soluble adjusting agent, and borate compound to form the tissue clearing composition.

53. The method of any one of paragraphs 38-52, further comprising, before or after incubating the tissue sample, one or more of the following steps, in any order:

(i) staining the tissue sample using one or more fluorescent dyes;

(ii) imaging one or more fluorescent proteins expressed in the tissue sample;

(iii) performing immunohistochemistry, fluorescent histochemistry, or both on the tissue sample; and

(iv) characterizing the tissue sample using transmission electron microscopy.

### EXAMPLES

### Example 1. Acid Screening

OPTIClear A (20 w/v % N-methylglucamine, 25 w/v % 2,2′-thiodiethanol, and 32 w/v % iohexol) required hydrochloric acid titration to achieve a neutral pH. Improving the tissue clearing capability of this composition for non-neural, non-osseous tissues or organs, e.g., formalin-fixed kidney tissues from rat and/or mouse, with or without previous paraffin-embedding, was performed by screening a group of organic and inorganic acids to replace hydrochloric acid.

A list of common acids, including organic acids such as acetic acid, succinic acid, maleic acid, malic acid, and glutamic acid as well as inorganic acids such as sulphuric acid, nitric acid, and phosphoric acid, were tested at a concentration of 1:1 molar ratio to N-methylglucamine. Interestingly, the organic acids tested invariably gave worse tissue-clearing results compared to OPTIClear A, suggesting that the choice of acid is important. Further, other common inorganic acids such as sulphuric acid, nitric acid, and phosphoric acid also failed to yield satisfactory tissue clearing.

Driven by these negative results, further screening of acids was performed to identify acids that once neutralized, would not give rise to separate anion which might impede the infiltration of N-methylglucamine into the tissue. Boric acid was identified to show improved tissue clearing for the kidney tissue, compared to all the other acids tested.

Boric acid can react with the vic-diols in N-methylglucamine to form a cyclic borate ester. Although it is possible that a dative bond might form between the electron-deficient boric acid and N-methylglucamine, ¹¹B NMR confirmed the cyclic borate formation to be more reasonable.

The boric acid-supplemented tissue clearing composition is denoted as OPTIClear B (20 w/v % N-methylglucamine, 25 w/v % 2,2′-thiodiethanol, 32 w/v % iohexol, and 6.335% w/v boric acid).

### Example 2. Tissue Clearing by OPTIClear B

Like OPTIClear A, OPTIClear B is detergent-free, non-toxic, and has a low iohexol concentration and thus less quenching of xanthene fluorophores. Compared to OPTIClear A, OPTIClear B is easier to prepare as boric acid can be added directly into the solid mix without titration.

OPTIClear B can clear 2-5 mm non-neural, non-osseous tissues ranging from formalin-fixed, non-paraffin-embedded mouse kidney, liver, spleen, and intestines to implanted mouse dermal tumors and to human kidney samples retrieved from paraffin-embedded blocks, without causing obvious tissue swelling, shrinkage, or distortion.

### Example 3. Three-Dimensional Imaging with OPTIClear B

OPTIClear B is compatible with a range of fluorescent tissue labelling reagents, such as lipophilic tracer, fluorophore-conjugated antibodies, fluorophore-conjugated lectins, fluorescent proteins, and nucleic acid stains. Combinations of these different stains were used to visualize different structures in formalin-fixed, non-paraffin-embedded tissue blocks. The stained tissues were then cleared by immersion in OPTIClear B. Confocal microscopy was used to generate 3D images of the renal structures and tumor structures in unprecedented detail. The staining was performed prior to the step of tissue clearing using OPTIClear B.

For example, 3D projected images of a 2 mm-thick, whole mouse kidney slice stained with the chemical stain DAPI (for nuclear DNA), AQP2 (for distal convoluted tubules), and Lycopersicon esculentum lectin (for various tubule types) proved compatibility of OPTIClear B with these staining methods. The formalin-fixed kidney slice was stained with the aforementioned stains and then cleared in OPTIClear B. 3D projected images can then be generated by confocal microscopy imaging of the cleared tissues.

In another example, 3D color-coded projection image and 3D rendering of mouse kidney, sectioned at 1 mm-thick transversely, which had been perfusion-stained by the lipophilic tracer dye DiI, were generated. DiI was transcardially injected into a sacrificed mouse, followed by perfusion fixation with formalin. The mouse kidney was dissected and sliced into 1 mm-thick sections, immersed in OPTIClear B, and imaged with confocal microscopy. The imaging result showed that thin cellular membranes of the endothelium remained intact after tissue clearing by OPTIClear B.

In another example, multiple classes of fluorescent stains, including DAPI (a nucleic acid stain), anti-laminin antibody (immunofluorescence), DiI (a lipophilic tracer for lipids), and Dylight 694-conjugated Lycopersicon esculentum lectin (lectin histochemistry for detecting glycosylations), were applied as stated in the previous examples. The multicolor-stained tissue was then immersed in OPTIClear B and imaged with confocal microscopy. This process generates 3D images of a mouse glomerulus from mouse renal tissue. The imaging result demonstrated that all the staining targets were well-preserved in the mouse renal tissue after tissue clearing.

In yet another example, multiple classes of fluorescent stains, including DAPI (a nucleic acid stain), GFP (fluorescent protein), DiI (a lipophilic tracer for lipids), and anti-CD31 antibody (immunofluorescence), were applied as stated in the previous examples. The multicolor-stained tissue was then immersed in OPTIClear B and imaged with confocal microscopy. This process generates 3D images of a mouse tumor implant. Again, the imaging result demonstrated that all the staining targets were well-preserved in the mouse tumor tissue after tissue clearing.

It is understood that the disclosed method and compositions are not limited to the particular methodology, protocols, and reagents described as these may vary. It is also to be understood that the terminology used herein is for the purpose of describing particular embodiments only, and is not intended to limit the scope of the present invention which will be limited only by the appended claims.

1. A tissue clearing composition comprising a homogenizing agent, a water-soluble adjusting agent, a lipid-soluble adjusting agent, and a borate compound.

2. The tissue clearing composition of claim 1, wherein the borate compound is a hydrogen or metal borate in an anhydrous or hydrous form.

3. The tissue clearing composition of claim 1, wherein the borate compound is a hydrogen borate selected from the group consisting of boric acid (H₃BO₃), metaboric acid (H₃B₃O₆), and tetraboric acid (H₂B₄O₇).

4. The tissue clearing composition of claim 1, wherein the borate compound is a metal borate having a boron-containing oxyanion selected from the group consisting of metaborates (BO₂⁻), diborate (B₂O₅⁴⁻), triborate (B₃O₇⁵⁻), tetraborate (B₄O₇²⁻, B₄O₅(OH)₄²⁻, B₄O₉⁶⁻, or combinations thereof), and hydroxyborate (B(OH)₄⁻).

5. The tissue clearing composition of claim 1, wherein the borate compound is selected from the group consisting of boric acid, tetraboric acid, disodium tetraborate, and derivatives thereof.

6. The tissue clearing composition of claim 1, wherein the molar ratio of the homogenizing agent to the borate compound is between about 0.5 and about 2, preferably about 1.

7. (canceled)

8. The tissue clearing composition of claim 1, wherein the homogenizing agent is a denaturant of proteins, nucleic acids, or a combination thereof.

9-12. (canceled)

13. The tissue clearing composition of claim 1, wherein the water-soluble adjusting agent, the lipid-soluble adjusting agent, or both have a refractive index higher than that of water at 25° C., preferably between about 1.40 and about 1.50 at 25° C.

14. (canceled)

15. The tissue clearing composition of claim 1, wherein the refractive index of the water-soluble adjusting agent is at or within 10% of the refractive index of the lipid-soluble adjusting agent at 25° C.

16-17. (canceled)

18. The tissue clearing composition of claim 1, wherein the lipid-soluble adjusting agent is miscible with water.

19-20. (canceled)

21. The tissue clearing composition of claim 1, wherein
(a) the homogenizing agent is selected from the group consisting of N-methylglucamine, urea, thiourea, guanidine, guanidinium chloride, lithium perchlorate, ethylenediamine, and derivatives thereof;
(b) the water-soluble adjusting agent is selected from the group consisting of iohexol, sodium thiosulfate, polyethylene glycol, and derivatives thereof;
(c) the lipid-soluble adjusting agent is selected from the group consisting of 2,2′-thiodiethanol, propylene glycol, and derivatives thereof; and
(d) the borate compound is selected from the group consisting of boric acid, tetraboric acid, disodium tetraborate, and derivatives thereof.

22. The tissue clearing composition of claim 21, wherein the homogenizing agent is N-methylglucamine, the water-soluble adjusting agent is iohexol, the lipid-soluble adjusting agent is 2,2′-thiodiethanol, and the borate compound is boric acid.

23. The tissue clearing composition of claim 22, wherein the concentration of each of N-methylglucamine, iohexol, and 2,2′-thiodiethanol ranges from about 10 to about 50 w/v %, and the molar ratio of N-methylglucamine to boric acid is between about 0.5 and about 2.

24. (canceled)

25. The tissue clearing composition of claim 21, wherein the homogenizing agent is N-methylglucamine, the water-soluble adjusting agent is iohexol, the lipid-soluble adjusting agent is propylene glycol, and the borate compound is boric acid.

26. The tissue clearing composition of claim 25, wherein the concentration of each of N-methylglucamine and iohexol ranges from about 10% to about 50%, the concentration of propylene glycol ranges from about 10 to about 60 w/v %, and the molar ratio of N-methylglucamine to boric acid is between about 0.5 and about 2.

27. (canceled)

28. The tissue clearing composition of claim 21, wherein the homogenizing agent is urea, the water-soluble adjusting agent is iohexol, the lipid-soluble adjusting agent is 2,2′-thiodiethanol, and the borate compound is boric acid.

29. The tissue clearing composition of claim 28, wherein the concentration of urea ranges from about 5 to about 50 w/v %, the concentration of each of iohexol and 2,2′-thiodiethanol ranges from about 10 to about 50 w/v %, and the molar ratio of urea to boric acid is between about 0.5 and about 2.

30. (canceled)

31. The tissue clearing composition of claim 1, further comprising one or more excipients selected from liquid vehicles, dispersion or suspension aids, surfactants, isotonic agents, thickening or emulsifying agents, preservatives, solid binders, lubricants, and combinations thereof.

32-34. (canceled)

35. The tissue clearing composition of claim 1, wherein the tissue clearing composition has a refractive index between about 1.4 and about 1.5 at 25° C.

36. The tissue clearing composition of claim 1, wherein the tissue clearing composition has a pH in the range from about 5 to about 9, from about 5.5 to about 8.5, from about 6 to about 8, or from about 7 to about 10.

37. The tissue clearing composition of claim 1, wherein the tissue clearing composition shows improved tissue clearing capacity for non-neural, non-osseous tissues or organs relative to corresponding compositions without the borate compound, relative to corresponding compositions with the borate compound replaced by an organic or inorganic acid, or relative to both.

38. A method of clearing tissues comprising incubating a tissue sample in the tissue clearing composition of claim 1.

39. The method of claim 38, wherein the homogenizing agent is N-methylglucamine, the water-soluble adjusting agent is iohexol, the lipid-soluble adjusting agent is 2,2′-thiodiethanol, and the borate compound is boric acid.

40. The method of claim 39, wherein the concentration of each of N-methylglucamine, iohexol, and 2,2′-thiodiethanol ranges from about 10 to about 50 w/v %, and the molar ratio of N-methylglucamine to boric acid is between about 0.5 and about 2.

41. The method of claim 40, wherein the concentration of N-methylglucamine is about 20 w/v %, the concentration of iohexol is about 32 w/v %, the concentration of thiodiethanol is about 25 w/v %, and the molar ratio of N-methylglucamine to boric acid is about 1.

42. The method of claim 38, wherein the tissue sample is incubated for a period of time ranging from about 3 to about 24 hours at a temperature ranging from about 37 to about 55° C.

43. The method of claim 38, wherein the tissue sample is a mammalian tissue sample, preferably a human tissue sample.

44. (canceled)

45. The method of claim 38, wherein the tissue sample is from a non-neural, non-osseous tissue or organ.

46. (canceled)

47. The method of claim 38, wherein the tissue sample is a renal tissue sample or a tumor tissue.

48-50. (canceled)

51. The method of claim 38, wherein the tissue sample is fresh, archived, or retrieved from a paraffin wax-embedded tissue.

52. The method of claim 38, further comprising, prior to incubating the tissue sample:
(a) selecting a homogenizing agent, a water-soluble adjusting agent, a lipid-soluble adjusting agent, and a borate compound; and
(b) mixing the homogenizing agent, water-soluble adjusting agent, lipid-soluble adjusting agent, and borate compound to form the tissue clearing composition.

53. The method of claim 38, further comprising, before or after incubating the tissue sample, one or more of the following steps, in any order:
(i) staining the tissue sample using one or more fluorescent dyes;
(ii) imaging one or more fluorescent proteins expressed in the tissue sample;
(iii) performing immunohistochemistry, fluorescent histochemistry, or both on the tissue sample; and
(iv) characterizing the tissue sample using transmission electron microscopy.
